(19) United States
(12) Patent Application Publication
(10) Pub. No.: US 2023/0018935 A1
(43) Pub. Date: Jan. 19, 2023

(54) TIRE MASTERBATCH, TIRE RUBBER COMPOSITION, TIRE, AND METHODS FOR MANUFACTURE THEREOF

(71) Applicant: Toyo Tire Corporation, Itami-shi (JP)

(72) Inventors: Souichiro Miura, Itami-shi (JP); Norio Minouchi, Itami-shi (JP)

(73) Assignee: Toyo Tire Corporation, Itami-shi (JP)

(21) Appl. No.: 17/846,463

(22) Filed: Jun. 22, 2022

(30) Foreign Application Priority Data
Jul. 9, 2021 (JP) 2021-114398

(51) Int. Cl. C08L 7/00; C08L 1/02; B60C 1/00

(52) U.S. Cl. CPC C08L 7/00; C08L 1/02; B60C 1/0016; C08L 2310/00

(57) ABSTRACT

A tire masterbatch comprises natural rubber and cellulose nanofiber, wherein at least a portion of the cellulose nanofiber is such that length is 10 μm to 20 μm, and a ratio (i.e., L/D) of the length to a diameter is 1000 to 2000. A tire masterbatch manufacturing method comprises an operation in which at least a cellulose nanofiber slurry and a natural rubber latex are mixed to prepare a liquid mixture, and an operation in which the liquid mixture is coagulated, wherein at least a portion of cellulose nanofiber within the cellulose nanofiber slurry is such that length is 10 μm to 20 μm, and a ratio (i.e., L/D) of the length to a diameter is 1000 to 2000.

### TECHNICAL FIELD

The invention relates to a tire masterbatch, a tire rubber composition, a tire, and to methods for manufacture thereof.

### BACKGROUND ART

Because cellulose fiber can be extracted from a wide variety of types of biomass and because it has little environmental impact, various research and development activities related to utilization of cellulose fiber—including utilization of cellulose fiber in pneumatic tires—are currently underway (see, for example, Patent Reference Nos. 1 through 4).

### PRIOR ART REFERENCES

### Patent References

Patent Reference No. 1: Japanese Patent Application Publication Kokai No. 2009-191198
Patent Reference No. 2: Japanese Patent Application Publication Kokai No. 2006-206864
Patent Reference No. 3: Japanese Patent Application Publication Kokai No. 2017-2148
Patent Reference No. 4: Japanese Patent Application Publication Kokai No. 2015-25141

### SUMMARY OF INVENTION

### Problem to be Solved by Invention

Whereas addition of cellulose nanofiber—like addition of carbon black—to rubber tends to cause improvement in rigidity of the vulcanized rubber, it also—like addition of carbon black—tends to cause worsening of ability to achieve reduced heat generation in the vulcanized rubber. Ability to achieve reduced heat generation is an important capability of the vulcanized rubber that makes up the tire. A vulcanized rubber such as will allow rigidity to be improved while permitting reduction in the degree to which worsening of ability to achieve reduced heat generation occurs due to cellulose nanofiber is therefore desired.

It is an object of the present invention to provide a masterbatch such as will serve as raw material for vulcanized rubber having an excellent balance between ability to achieve reduced heat generation and rigidity, and a method for manufacture thereof. In addition, it is an object of the present invention to provide a rubber composition such as will serve as raw material for vulcanized rubber having an excellent balance between ability to achieve reduced heat generation and rigidity. What is referred to here as “an excellent balance between ability to achieve reduced heat generation and rigidity” means that the effect whereby rigidity is improved due to cellulose nanofiber is comparatively large while the degree to which ability to achieve reduced heat generation is worsened due to cellulose nanofiber is comparatively small.

### Means for Solving Problem

A tire masterbatch in accordance with the present invention, which is one means for solving such problem(s), comprises
natural rubber; and
cellulose nanofiber;

wherein at least a portion of the cellulose nanofiber is such that length is 10 μm to 20 μm, and a ratio (hereinafter sometimes referred to as “LID”) of the length to a diameter is 1000 to 2000.

Tire masterbatch in accordance with the present invention, because it comprises cellulose nanofiber, permits improvement in rigidity of vulcanized rubber.

Moreover, causing at least a portion of the cellulose nanofiber to be such that length is 10 μm to 20 μm and such that L/D is 1000 to 2000 makes it possible for rigidity of the vulcanized rubber to be improved even further. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree. This is in addition thought to be due to the fact that causing length to be not less than 10 μm and causing L/D to be not less than 1000 permits effective manifestation of the cellulose nanofiber reinforcement effect.

And what is more, this permits mitigation of the degree to which cellulose nanofiber causes worsening in the ability to achieve reduced heat generation. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree.

A tire masterbatch manufacturing method in accordance with the present invention comprises
an operation in which at least a cellulose nanofiber slurry and a natural rubber latex are mixed to prepare a liquid mixture; and
an operation in which the liquid mixture is coagulated;

wherein at least a portion of cellulose nanofiber within the cellulose nanofiber slurry is such that length is 10 μm to 20 μm, and a ratio of the length to a diameter is 1000 to 2000.

Because a tire masterbatch manufacturing method in accordance with the present invention adopts a procedure in which a cellulose nanofiber slurry and a natural rubber latex are mixed, and a liquid mixture is coagulated, it makes it possible to cause dispersion of cellulose nanofiber to a higher degree than would be the case were cellulose nanofiber added to natural rubber and this kneaded in a Banbury mixer and makes it possible to improve rigidity of vulcanized rubber.

Moreover, causing at least a portion of the cellulose nanofiber to be such that length is 10 μm to 20 μm and such that L/D is 1000 to 2000 makes it possible for rigidity of the vulcanized rubber to be improved even further. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree. This is in addition thought to be due to the fact that causing length to be not less than 10 μm and causing L/D to be not less than 1000 permits effective manifestation of the cellulose nanofiber reinforcement effect.

And what is more, this permits mitigation of the degree to which cellulose nanofiber causes worsening in the ability to achieve reduced heat generation. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree.

It is preferred that the constitution of a tire masterbatch manufacturing method in accordance with the present invention be such that, at the operation in which the liquid mixture is prepared, at least the cellulose nanofiber slurry, the natural rubber latex, and a carbon black slurry be mixed. In accordance with such constitution, because cellulose nanofiber slurry, natural rubber latex, and carbon black slurry are mixed, it is possible to even further reduce the degree to which cellulose nanofiber causes worsening in ability to achieve reduced heat generation, and it is possible to even further improve rigidity of vulcanized rubber. It is thought that the reason for this is that mixture of these makes it possible to promote dispersion of carbon black and cellulose nanofiber as cellulose nanofiber is incorporated into flocculated clumps of carbon black, as a result of which dispersion of carbon black to a high degree is made possible.

A tire manufacturing method in accordance with the present invention comprises an operation in which a tire masterbatch is prepared in accordance with a manufacturing method as described above;

an operation in which the tire masterbatch is used to prepare a rubber composition; and

an operation in which the rubber composition is used to prepare an unvulcanized tire.

A tire rubber composition in accordance with the present invention comprises
natural rubber; and
cellulose nanofiber;

wherein at least a portion of the cellulose nanofiber is such that length is 10 μm to 20 μm, and a ratio of the length to a diameter is 1000 to 2000.

A tire rubber composition in accordance with the present invention, because it comprises cellulose nanofiber, permits improvement in rigidity of vulcanized rubber.

Moreover, causing at least a portion of the cellulose nanofiber to be such that length is 10 μm to 20 μm and such that L/D is 1000 to 2000 makes it possible for rigidity of the vulcanized rubber to be improved even further. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree. This is in addition thought to be due to the fact that causing length to be not less than 10 μm and causing L/D to be not less than 1000 permits effective manifestation of the cellulose nanofiber reinforcement effect.

And what is more, this permits mitigation of the degree to which cellulose nanofiber causes worsening in the ability to achieve reduced heat generation. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree.

A tire in accordance with the present invention is a tire prepared using a rubber composition as described above.

### EMBODIMENTS FOR CARRYING OUT INVENTION

Below, description is given with respect to embodiments of the present invention.

### 1. Masterbatch Manufacturing Method

A masterbatch manufacturing method in accordance with the present embodiment comprises an operation (hereinafter sometimes referred to as “Operation A”) in which at least a cellulose nanofiber slurry and a natural rubber latex are mixed to prepare a liquid mixture, and an operation (hereinafter sometimes referred to as “Operation B”) in which the liquid mixture is coagulated. Because a masterbatch manufacturing method in accordance with the present embodiment comprises Operation A and Operation B, it makes it possible to cause dispersion of cellulose nanofiber to a higher degree than would be the case were cellulose nanofiber added to natural rubber and this kneaded in a Banbury mixer and makes it possible to improve rigidity of the vulcanized rubber. A masterbatch manufacturing method in accordance with the present embodiment may further comprise an operation (hereinafter sometimes referred to as “Operation C”) in which the coagulum is dewatered.

1.1. Operation A (Operation in which Liquid Mixture is Prepared)

At Operation A, at least a cellulose nanofiber slurry and a natural rubber latex are mixed to prepare a liquid mixture. During such mixing, a disperser—e.g., a high-shear mixer, homomixer, ball mill, bead mill, high-pressure homogenizer, ultrasonic homogenizer, colloid mill, and/or the like—may be used.

The cellulose nanofiber slurry may contain cellulose nanofiber and water. In the cellulose nanofiber slurry, cellulose nanofiber may be dispersed in water. Where necessary, the cellulose nanofiber slurry may contain any of various other additives, e.g., organic solvents and surface active agents.

As cellulose nanofiber raw materials, wood, rice husks, straw, bamboo, and so forth may be cited as examples. Where the raw material is pulp, a method which includes a procedure by which the pulp, after being subjected to chemical treatment and/or enzymatic treatment, is fibrillated in water might, for example, be used to obtain cellulose nanofiber. A method which includes a procedure by which pulp that has not been subjected to chemical treatment or enzymatic treatment is mechanically fibrillated in water may also be used to obtain cellulose nanofiber. Of these, the latter procedure is preferred.

At least a portion of the cellulose nanofiber is such that length is 10 μm to 20 μm, and the ratio of length to diameter, i.e., L/D, is 1000 to 2000. Such constitution will permit yet further improvement in rigidity of the vulcanized rubber. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree. This is in addition thought to be due to the fact that causing length to be not less than 10 μm and causing L/D to be not less than 1000 permits effective manifestation of the cellulose nanofiber reinforcement effect. What is more, this will permit mitigation of the degree to which cellulose nanofiber causes worsening in the ability to achieve reduced heat generation. It is thought that the reason for this is that causing length to be not greater than 20 μm and causing L/D to be not greater than 2000 makes it possible to prevent viscosity of the cellulose nanofiber slurry from becoming excessively high and makes it possible to cause the cellulose nanofiber to be dispersed to a high degree.

The cellulose nanofiber may be such that length of at least a portion thereof is not less than 13 μm, or is not less than 15 μm. L/D may be not less than 1300, or may be not less than 1500. L/D may be less than 2000. Length, diameter, and L/D of cellulose nanofiber are the values thereof as measured in accordance with the methods described at the working examples, described below.

As natural rubber latex, concentrated natural rubber latex and field latex may be cited as examples. In the natural rubber latex, rubber particles may be dispersed in colloidal fashion in dispersion medium. More specifically, in the natural rubber latex, rubber particles may be dispersed in colloidal fashion in water. The natural rubber latex may contain organic solvent. Thus, the dispersion medium might, for example, be water that contains organic solvent.

It is preferred that dry rubber content of the natural rubber latex be not less than 10 mass %, and more preferred that this be not less than 20 mass %. The upper limit of the range in values for the dry rubber content of the natural rubber latex might, for example, be 60 mass % or 50 mass %.

Mixture of natural rubber latex and cellulose nanofiber slurry may be carried out so as to preferably cause there to be not less than 0.1 part by mass, more preferably not less than 1 part by mass, still more preferably not less than 3 parts by mass, and still more preferably not less than 5 parts by mass, of cellulose nanofiber per 100 parts by mass of dry rubber content in the natural rubber latex. Such mixture may be carried out so as to preferably cause there to be not greater than 60 parts by mass, more preferably not greater than 50 parts by mass, still more preferably not greater than 40 parts by mass, and still more preferably not greater than 30 parts by mass, of cellulose nanofiber per 100 parts by mass of dry rubber content in the natural rubber latex.

At Operation A, it is preferred that, together with the natural rubber latex and the cellulose nanofiber slurry, a carbon black slurry be mixed therein. By causing a carbon black slurry to be mixed therein together with the natural rubber latex and the cellulose nanofiber slurry, it will be possible to even further reduce the degree to which cellulose nanofiber causes worsening in ability to achieve reduced heat generation, and it will be possible to even further improve rigidity of the vulcanized rubber. It is thought that the reason for this is that mixture of these makes it possible to promote dispersion of carbon black and cellulose nanofiber as cellulose nanofiber is incorporated into flocculated clumps of carbon black, as a result of which dispersion of carbon black to a high degree is made possible.

The carbon black slurry may contain carbon black and water. In the carbon black slurry, carbon black may be dispersed in water. The carbon black slurry may be obtained by adding carbon black to water and subjecting this to agitation. During agitation, a disperser—e.g., a high-shear mixer, homomixer, ball mill, bead mill, high-pressure homogenizer, ultrasonic homogenizer, colloid mill, and/or the like—may be used. Where necessary, the carbon black slurry may contain any of various other additives, e.g., organic solvents and surface active agents.

As examples of carbon black, besides SAF, ISAF, HAF, FEF, GPF, and/or other such furnace blacks, acetylene black, Ketchen black, and/or other such electrically conductive carbon blacks may be used. The carbon black may be nongranulated carbon black or may be granulated carbon black that has been granulated based upon considerations related to the handling characteristics thereof. Any one thereamong may be used, or any two or more thereamong may be used.

It is preferred that the amount of carbon black in the carbon black slurry be not less than 1 mass %, more preferred that this be not less than 2 mass %, and still more preferred that this be not less than 3 mass %, per 100 mass % of the carbon black slurry. It is preferred that the amount of carbon black in the carbon black slurry be not greater than 30 mass %, more preferred that this be not greater than 25 mass %, still more preferred that this be not greater than 20 mass %, still more preferred that this be not greater than 15 mass %, and still more preferred that this be not greater than 10 mass %, per 100 mass % of the carbon black slurry.

Mixture of the carbon black slurry may be carried out so as to preferably cause there to be not less than 0.1 part by mass, more preferably not less than 0.5 part by mass, and still more preferably not less than 1 part by mass, of carbon black per 100 parts by mass of dry rubber content in the natural rubber latex. Such mixture may be carried out so as to preferably cause there to be not greater than 20 parts by mass, more preferably not greater than 10 parts by mass, and still more preferably not greater than 5 parts by mass, of carbon black per 100 parts by mass of dry rubber content in the natural rubber latex.

1.2. Operation B (Operation in which Liquid Mixture is Coagulated)

At Operation B, the liquid mixture is coagulated. That is, cellulose nanofiber and rubber particles within the liquid mixture are made to mutually coagulate. Where the liquid mixture contains carbon black, carbon black may also be made to mutually coagulate together with cellulose nanofiber and rubber particles. To cause coagulation of the liquid mixture, coagulant may be added to the liquid mixture. The coagulant might, for example, be an acid. As the acid, formic acid, sulfuric acid, and the like may be cited as examples. Addition of coagulant may be carried out while agitating the liquid mixture, may be carried out while heating the liquid mixture, or may be carried out in state(s) constituting any desired combination thereof (i.e., agitation and/or heating). Of course, the liquid mixture may be coagulated without use of coagulant.

Following coagulation, the coagulum may be separated from waste liquid as necessary. The coagulum might, for example, take the form of small pieces. Note that coagulum in the form of small pieces is sometimes referred to as “crumbs.” A filter might, for example, be employed to separate coagulum from waste liquid.

1.3. Operation C (Operation in which Coagulum is Dewatered)

At Operation C, the coagulum is dewatered. An extruder, oven, vacuum dryer, and/or air dryer might, for example, be used to dewater the coagulum. Of these, an extruder is preferred. Use of an extruder will make it possible to dewater the coagulum through compaction and/or other effects, and will make it possible to cause the dewatered coagulum to be plasticized as it is dried. As the extruder, a single-screw extruder may be cited as an example.

### 1.4. Other Operations

The extruded coagulum, i.e., the dewatered coagulum, may be cut as necessary, and may be compressed and formed into any desired shape (e.g., into bales) as necessary. A pelletizer might, for example, be used to carry out cutting.

The masterbatch thus obtained may take the form of bales. The form taken by the masterbatch is not limited to bales, it being possible for this to take the form of pellets, to take the form of rods, or to take the form of sheets.

The masterbatch comprises a rubber component that comprises natural rubber. The amount of natural rubber might, for example, be not less than 80 mass %, might be not less than 90 mass %, or might be 100 mass %, per 100 mass % of rubber component within the masterbatch.

The masterbatch may comprise cellulose nanofiber. Where the masterbatch comprises cellulose nanofiber, this will permit improvement in the rigidity of the vulcanized rubber. It is preferred that the amount of cellulose nanofiber be not less than 0.1 part by mass, more preferred that this be not less than 1 part by mass, still more preferred that this be not less than 3 parts by mass, and still more preferred that this be not less than 5 parts by mass, per 100 parts by mass of rubber component. It is preferred that the amount of cellulose nanofiber be not greater than 60 parts by mass, more preferred that this be not greater than 50 parts by mass, still more preferred that this be not greater than 40 parts by mass, and still more preferred that this be not greater than 30 parts by mass, per 100 parts by mass of rubber component.

The masterbatch may comprise carbon black. It is preferred that the amount of carbon black be not less than 0.1 part by mass, more preferred that this be not less than 0.5 part by mass, and still more preferred that this be not less than 1 part by mass, per 100 parts by mass of rubber component. It is preferred that the amount of carbon black be not greater than 20 parts by mass, more preferred that this be not greater than 10 parts by mass, and still more preferred that this be not greater than 5 parts by mass, per 100 parts by mass of rubber component.

### 2. Tire Manufacturing Method

A tire manufacturing method in accordance with the present embodiment comprises an operation in which masterbatch is prepared in accordance with a method as described above, an operation in which the masterbatch is used to prepare a rubber composition, and an operation in which the rubber composition is used to prepare an unvulcanized tire.

2.1. Operation in which Masterbatch is Used to Prepare Rubber Composition

This operation (more specifically, an operation in which masterbatch is used to prepare a rubber composition) may comprise kneading at least masterbatch and compounding ingredient(s) to prepare a rubber mixture, and kneading at least the rubber mixture and vulcanizing-type compounding ingredient(s) to obtain a rubber composition.

At this operation, at least masterbatch and compounding ingredient(s) are kneaded to prepare a rubber mixture. As compounding ingredient(s), filler, zinc oxide, stearic acid, wax, antioxidant, silane coupling agent, vulcanizing-type compounding ingredient, and the like may be cited as examples. One or any desired combination may be chosen from thereamong and used as compounding ingredient(s). Note, however, that it is preferred that vulcanizing-type compounding ingredient not be added at this stage. As filler, carbon black, silica, clay, talc, calcium carbonate, magnesium carbonate, aluminum hydroxide, and the like may be cited as examples. One or any desired combination may be chosen from thereamong and used as the filler. Where carbon black is added at this stage, the properties of such carbon black may be the same as or may be different from the properties of carbon black used in the carbon black slurry. For example, the grade of any carbon black which may be added at this stage may be the same as or may be different from the grade of carbon black used in the carbon black slurry, as defined by ASTM (American Society for Testing and Materials). As antioxidant, aromatic-amine-type antioxidant, amine-ketone-type antioxidant, monophenol-type antioxidant, bisphenol-type antioxidant, polyphenol-type antioxidant, dithiocarbamate-type antioxidant, thiourea-type antioxidant, and the like may be cited as examples. One or any desired combination may be chosen from thereamong and used as the antioxidant. Other rubber(s) may be kneaded therein together with the masterbatch and compounding ingredient(s). As such rubbers, natural rubber, polyisoprene rubber, styrene-butadiene rubber, nitrile rubber, chloroprene rubber, and the like may be cited as examples. One or any desired combination may be chosen from thereamong and used. Kneading may be carried out using a kneader. As the kneader, internal kneaders, open roll mills, and the like may be cited as examples. As an internal kneader, Banbury mixers, kneaders, and the like may be cited as examples.

At this operation, at least the rubber mixture and vulcanizing-type compounding ingredient(s) are kneaded to obtain a rubber composition. As vulcanizing-type compounding ingredients, sulfur, organic peroxides, and other such vulcanizing agents, vulcanization accelerators, vulcanization accelerator activators, vulcanization retarders, and so forth may be cited as examples. One or any desired combination may be chosen from thereamong and used as the vulcanizing-type compounding ingredient. As sulfur, powdered sulfur, precipitated sulfur, insoluble sulfur, high dispersing sulfur, and the like may be cited as examples. One or any desired combination may be chosen from thereamong and used as the sulfur. As vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited as examples. One or any desired combination may be chosen from thereamong and used as the vulcanization accelerator. Kneading may be carried out using a kneader. As the kneader, internal kneaders, open roll mills, and the like may be cited as examples. As an internal kneader, Banbury mixers, kneaders, and the like may be cited as examples.

The rubber composition comprises rubber component originating from the masterbatch. The amount of rubber component originating from the masterbatch might be not less than 20 mass %, not less than 40 mass %, might be not less than 60 mass %, might be not less than 80 mass %, or might be 100 mass %, per 100 mass % of rubber within the rubber composition, for example.

The rubber composition comprises cellulose nanofiber. Because the rubber composition comprises cellulose nanofiber, improvement in the rigidity of the vulcanized rubber is made possible. It is preferred that the amount of cellulose nanofiber be not less than 0.1 part by mass, more preferred that this be not less than 1 part by mass, still more preferred that this be not less than 3 parts by mass, and still more preferred that this be not less than 5 parts by mass, per 100 parts by mass of rubber in the rubber composition. It is preferred that the amount of cellulose nanofiber be not greater than 60 parts by mass, more preferred that this be not greater than 50 parts by mass, still more preferred that this be not greater than 40 parts by mass, and still more preferred that this be not greater than 30 parts by mass, per 100 parts by mass of rubber in the rubber composition.

The rubber composition may comprise carbon black. It is preferred that the amount of carbon black be not less than 0.1 part by mass, more preferred that this be not less than 0.5 part by mass, and still more preferred that this be not less than 1 part by mass, per 100 parts by mass of rubber in the rubber composition. It is preferred that the amount of carbon black be not greater than 20 parts by mass, more preferred that this be not greater than 10 parts by mass, and still more preferred that this be not greater than 5 parts by mass, per 100 parts by mass of rubber in the rubber composition.

The rubber composition may further comprise zinc oxide, stearic acid, wax, antioxidant, silica, silane coupling agent, sulfur, vulcanization accelerator, and/or the like. The rubber composition may comprise one or any desired combination thereamong. It is preferred that the amount of the sulfur, expressed as equivalent sulfur content, be 0.5 part by mass to 5 parts by mass, per 100 parts by mass of rubber within the rubber composition. It is preferred that the amount of vulcanization accelerator be 0.1 part by mass to 5 parts by mass, per 100 parts by mass of rubber within the rubber composition.

The rubber composition may be used to prepare a tire. More specifically, it is capable of being used in preparing tire member(s) making up a tire. For example, the rubber composition may be used in preparing tread rubber, sidewall rubber, chafer rubber, bead filler rubber, and/or the like. The rubber composition may be used to prepare one or any desired combination among such tire member(s).

2.2. Operation in which Rubber Composition is Used to Prepare Unvulcanized Tire

A tire manufacturing method in accordance with the present embodiment comprises an operation in which a rubber composition is used to prepare an unvulcanized tire. This operation may comprise preparing tire member(s) comprising a rubber composition, and preparing an unvulcanized tire comprising the tire member(s). As tire members, tread rubber, sidewall rubber, chafer rubber, and bead filler rubber may be cited as examples. Of these, tread rubber is preferred.

### 2.3. Other Operations

A tire manufacturing method in accordance with the present embodiment may further comprise an operation in which the unvulcanized tire is vulcanized and molded. The tire obtained in accordance with the method of the present embodiment may be a pneumatic tire.

### 3. Various Modifications May be Made to the Foregoing Embodiment

Various modifications may be made to the foregoing embodiment. For example, modifications which may be made to the foregoing embodiment might include any one or more variations chosen from among the following.

The foregoing embodiment was described in terms of a constitution in which water is used to prepare a carbon black slurry. However, the foregoing embodiment is not limited to this constitution. For example, dilute rubber latex may be used instead of water. More specifically, a carbon black slurry might be prepared through employment of a procedure in which carbon black is added to dilute rubber latex, and this is agitated. In the dilute rubber latex, rubber particles may be dispersed in colloidal fashion in water. The water might, for example, be water that contains organic solvent. It is preferred that dry rubber content of the dilute rubber latex be not less than 0.1 mass %, and more preferred that this be not less than 0.3 mass %. It is preferred that the upper limit of the range in values for the dry rubber content be 5 mass %, and more preferred that this be 2 mass %. The dilute rubber latex might, for example, be prepared through employment of a procedure in which natural rubber latex is diluted with water. Synthetic rubber latex may be used instead of natural rubber latex.

The foregoing embodiment was described in terms of a constitution in which masterbatch is prepared in accordance with a method comprising Operation A and Operation B. However, the foregoing embodiment is not limited to this constitution. For example, the masterbatch might be prepared in accordance with a method in which at least cellulose nanofiber and natural rubber are kneaded.

The foregoing embodiment was described in terms of a constitution in which masterbatch and compounding ingredient(s) are kneaded to prepare a rubber mixture. However, the foregoing embodiment is not limited to this constitution. For example, the rubber mixture may be deemed to be the masterbatch.

The foregoing embodiment was described in terms of a constitution in which the tire is a pneumatic tire. However, the foregoing embodiment is not limited to this constitution.

### WORKING EXAMPLES

Working examples in accordance with the present invention are described below.

The raw materials and reagents that were used at the Working Examples are indicated below.

Concentrated natural rubber latex (dry rubber content 60 mass %)

| | Manufactured by Regitex Co., Ltd. |
|---|---|
| Natural rubber | RSS #3 |
| Carbon black | “SEAST 3” (N330) manufactured by Tokai Carbon |
| | Co., Ltd. |
| CNF1 | “IMa-10002” manufactured by Sugino Machine |
| | Limited |
| | Concentration 2 wt %; fiber diameter 10 nm-50 nm; |
| | fiber length 10 μm-20 μm; viscosity 7,000 mPa · s |
| | (under conditions of 25° C. and 60 rpm (B-type |
| | viscometer)) |
| CNF2 | “WFo-10002” manufactured by Sugino Machine |
| | Limited |
| | Concentration 2 wt %; fiber diameter 10 nm-50 nm; |
| | fiber length 1 μm-9 μm; viscosity 6,000 mPa · s |
| | (under conditions of 25° C. and 60 rpm (B-type |
| | viscometer) |
| CNF3 | “Rheocrysta” manufactured by DKS Co. Ltd. |
| | Concentration 2 wt %; fiber diameter 3 nm; viscosity |
| | not less than 10,000 mPa · s (resulting from |
| | concentration 1.0 wt %; measurement conditions: BM- |
| | type viscometer; 6 rpm; 3 min; 20° C.) |
| Zinc oxide | “Zinc Oxide Variety No. 2” manufactured by Mitsui |
| | Mining & Smelting Co., Ltd. |
| Stearic acid | “LUNAC S-20” manufactured by Kao Corporation |
| Wax | “OZOACE 0355” manufactured by Nippon Seiro Co., |
| | Ltd. |
| Antioxidant A | “NOCRAC 6C” (N-phenyl-N′-(1,3-dimethylbutyl)-p- |
| | phenylenediamine) manufactured by Ouchi Shinko |
| | Chemical Industrial Co., Ltd. |
| Antioxidant B | “NOCRAC 224” (2,2,4-trimethyl-1,2- |
| | dihydroquinoline polymer) manufactured by Ouchi |
| | Shinko Chemical Industrial Co., Ltd. |
| Sulfur | “5% Oil Treated Sulfur Powder” manufactured by |
| | Tsurumi Chemical Industry Co., Ltd. |
| Vulcanization accelerator | “Sanceler CM” (N-cyclohexyl-2- |
| | benzothiazolesulfenamide) manufactured by Sanshin |
| | Chemical Industry Co., Ltd. |

### Measurement of Cellulose Nanofiber Length and Diameter

Cellulose nanofiber—specifically CNF1, 2, and 3—are slurry-like products. These products were diluted with distilled water. The diluent (i.e., diluted liquid dispersion of CNF) was dripped onto a grid and allowed to dry, following which a Field-Emission Scanning Electron Microscope, i.e., FE-SEM, was used to observe the cellulose nanofiber. The conditions under which observation was carried out are as follows.

| | |
|---|---|
| Magnification under which observation carried out | 2000x |
| Working distance | WD = 2 mm |
| Detector | InLens |
| Electron beam accelerating voltage | 1 kV |

Length and diameter of cellulose nanofibers appearing in FE-SEM images were measured. Ratio of length to diameter, i.e., L/D, was calculated from these measured values.

Cellulose nanofiber length and L/D were as follows (representative values).

| | | |
|---|---|---|
| CNF1 | Length 19 μm | L/D 1727 |
| CNF2 | Length 8 μm | L/D 258 |
| CNF3 | Length 30 μm | L/D 2500 |

### Preparation of Masterbatch at Comparative Examples 4-6 and 10-12, and at Working Examples 1-3

The cellulose nanofiber indicated at TABLES 1 and 2 was agitated for 30 minutes at 1000 rpm in a mixer (“SM-20 Supermixer” manufactured by Kawata Co., Ltd.) to obtain a cellulose nanofiber slurry. Concentrated natural rubber latex was added to the cellulose nanofiber slurry in accordance with the blended amounts shown in TABLES 1 and 2, and this was agitated for 30 minutes at 1000 rpm in a mixer (“SM-20 Supermixer” manufactured by Kawata Co., Ltd.) to obtain a liquid mixture. The liquid mixture was placed in an oven and was dried overnight at 70° C. Masterbatch was obtained as a result of such procedure.

### Preparation of Masterbatch at Comparative Examples 7-9 and 13-15, and at Working Examples 4-12

Carbon black was added to water and this was agitated to obtain a carbon black slurry. The cellulose nanofiber indicated at TABLES 1 and 2 was agitated for 30 minutes at 1000 rpm in a mixer (“SM-20 Supermixer” manufactured by Kawata Co., Ltd.) to obtain a cellulose nanofiber slurry. Concentrated natural rubber latex and the carbon black slurry were added to the cellulose nanofiber slurry in accordance with the blended amounts shown in TABLES 1 and 2, and this was agitated for 30 minutes at 1000 rpm in a mixer (“SM-20 Supermixer” manufactured by Kawata Co., Ltd.) to obtain a liquid mixture. The liquid mixture was placed in an oven and was dried overnight at 70° C. Masterbatch was obtained as a result of such procedure.

### Preparation of Unvulcanized Rubber at Respective Examples Other than Comparative Examples 1-3 (i.e., Comparative Examples 4-15 and Working Examples 4-12)

The compounding ingredients except for sulfur and vulcanization accelerator were added to masterbatch in accordance with TABLES 1 and 2, and a Banbury mixer was used to carry out kneading to obtain a rubber mixture. The rubber mixture was kneaded with sulfur and vulcanization accelerator in a Banbury mixer to obtain unvulcanized rubber.

### Preparation of Unvulcanized Rubber at Comparative Examples 1-3

The compounding ingredients except for sulfur and vulcanization accelerator were added to natural rubber in accordance with TABLES 1 and 2, and a Banbury mixer was used to carry out kneading to obtain a rubber mixture. The rubber mixture was kneaded with sulfur and vulcanization accelerator in a Banbury mixer to obtain unvulcanized rubber.

### Preparation of Vulcanized Rubber

The unvulcanized rubber was vulcanized for 30 minutes at 150° C. to obtain vulcanized rubber.

### E′ (Storage Modulus)

E′, i.e., storage modulus, of vulcanized rubber was measured in accordance with JIS K-6394. More specifically, measurement was carried out using a viscoelasticity testing machine under conditions of room temperature, frequency 10 Hz, static strain 5%, and dynamic strain 1%. E of the respective Examples are shown at TABLES 1 and 2 as indexed relative to a value of 100 for the E of Comparative Example 6. The higher the index the greater the E, and thus the better the rigidity.

tan δ

tan δ of vulcanized rubber was measured in accordance with JIS K-6394. More specifically, measurement was carried out using a viscoelasticity testing machine under conditions of temperature 70° C., frequency 10 Hz, static strain 5%, and dynamic strain 1%. tan δ of the respective Examples are shown at TABLES 1 and 2 as indexed relative to a value of 100 for the tan δ of Comparative Example 6. The lower the index the less the tendency for heat generation to occur, and thus the better the ability to achieve reduction in fuel consumption when used as a tire.

TABLE 1

| | | Comparative Examples | | | | | | | |
|---|---|---|---|---|---|---|---|---|---|
| | | 1 | 2 | 3 | 4 | 5 | 6 | 7 | 8 |
| Amount blended in masterbatch | | | | | | | | | |
| Parts | Concentrated natural | — | — | — | 100 | 100 | 100 | 100 | 100 |
| by | rubber latex (dry | | | | | | | | |
| mass | rubber content) | | | | | | | | |
| | Carbon black | — | — | — | — | — | — | 2 | 2 |
| | CNF1 | — | — | — | — | — | — | — | — |
| | CNF2 | — | — | — | 10 | 20 | 30 | 10 | 20 |
| | CNF3 | — | — | — | — | — | — | — | — |
| Amount blended in rubber composition | | | | | | | | | |
| Parts | Masterbatch | — | — | — | 110 | 120 | 130 | 112 | 122 |
| by | Natural rubber | 100 | 100 | 100 | — | — | — | — | — |
| mass | (RSS #3) | | | | | | | | |
| | Carbon black | 35 | 40 | 50 | — | — | — | — | — |
| | Zinc oxide | 3 | 3 | 3 | 3 | 3 | 3 | 3 | 3 |
| | Stearic acid | 2 | 2 | 2 | 2 | 2 | 2 | 2 | 2 |
| | Wax | 1 | 1 | 1 | 1 | 1 | 1 | 1 | 1 |
| | Antioxidant A | 2 | 2 | 2 | 2 | 2 | 2 | 2 | 2 |
| | Antioxidant B | 1 | 1 | 1 | 1 | 1 | 1 | 1 | 1 |
| | Sulfur | 2 | 2 | 2 | 2 | 2 | 2 | 2 | 2 |
| | Vulcanization | 1 | 1 | 1 | 1 | 1 | 1 | 1 | 1 |
| | accelerator | | | | | | | | |
| Physical | E′ | 100 | 106 | 121 | 56 | 82 | 100 | 58 | 83 |
| properties | tanδ | 109 | 115 | 128 | 83 | 94 | 100 | 86 | 95 |

| | | Comparative Examples | | | | | | |
|---|---|---|---|---|---|---|---|---|
| | | 9 | 10 | 11 | 12 | 13 | 14 | 15 |
| Amount blended in masterbatch | | | | | | | | |
| Parts | Concentrated natural | 100 | 100 | 100 | 100 | 100 | 100 | 100 |
| by | rubber latex (dry | | | | | | | |
| mass | rubber content) | | | | | | | |
| | Carbon black | 2 | — | — | — | 2 | 2 | 2 |
| | CNF1 | — | — | — | — | — | — | — |
| | CNF2 | 30 | — | — | — | — | — | — |
| | CNF3 | — | 10 | 20 | 30 | 10 | 20 | 30 |
| Amount blended in rubber composition | | | | | | | | |
| Parts | Masterbatch | 132 | 110 | 120 | 130 | 112 | 122 | 132 |
| by | Natural rubber | — | — | — | — | — | — | — |
| mass | (RSS #3) | | | | | | | |
| | Carbon black | — | — | — | — | — | — | — |
| | Zinc oxide | 3 | 3 | 3 | 3 | 3 | 3 | 3 |
| | Stearic acid | 2 | 2 | 2 | 2 | 2 | 2 | 2 |
| | Wax | 1 | 1 | 1 | 1 | 1 | 1 | 1 |
| | Antioxidant A | 2 | 2 | 2 | 2 | 2 | 2 | 2 |
| | Antioxidant B | 1 | 1 | 1 | 1 | 1 | 1 | 1 |
| | Sulfur | 2 | 2 | 2 | 2 | 2 | 2 | 2 |
| | Vulcanization | 1 | 1 | 1 | 1 | 1 | 1 | 1 |
| | accelerator | | | | | | | |
| Physical | E′ | 101 | 96 | 108 | 119 | 98 | 109 | 120 |
| properties | tanδ | 101 | 109 | 114 | 121 | 109 | 113 | 121 |

TABLE 2

| | | Working Examples | | | | | |
|---|---|---|---|---|---|---|---|
| | | 1 | 2 | 3 | 4 | 5 | 6 |
| Amount blended in masterbatch | | | | | | | |
| Parts | Concentrated natural | 100 | 100 | 100 | 100 | 100 | 100 |
| by | rubber latex (dry | | | | | | |
| mass | rubber content) | | | | | | |
| | Carbon black | — | — | — | 2 | 2 | 2 |
| | CNF1 | 10 | 20 | 30 | 10 | 20 | 30 |
| | CNF2 | — | — | — | — | — | — |
| | CNF3 | — | — | — | — | — | — |
| Amount blended in rubber composition | | | | | | | |
| Parts | Masterbatch | 110 | 120 | 130 | 112 | 122 | 132 |
| by | Natural rubber | — | — | — | — | — | — |
| mass | (RSS #3) | | | | | | |
| | Carbon black | — | — | — | — | — | — |
| | Zinc oxide | 3 | 3 | 3 | 3 | 3 | 3 |
| | Stearic acid | 2 | 2 | 2 | 2 | 2 | 2 |
| | Wax | 1 | 1 | 1 | 1 | 1 | 1 |
| | Antioxidant A | 2 | 2 | 2 | 2 | 2 | 2 |
| | Antioxidant B | 1 | 1 | 1 | 1 | 1 | 1 |
| | Sulfur | 2 | 2 | 2 | 2 | 2 | 2 |
| | Vulcanization | 1 | 1 | 1 | 1 | 1 | 1 |
| | accelerator | | | | | | |
| Physical | E′ | 120 | 126 | 152 | 125 | 131 | 156 |
| properties | tanδ | 94 | 96 | 103 | 92 | 93 | 101 |

| | | Working Examples | | | | | |
|---|---|---|---|---|---|---|---|
| | | 7 | 8 | 9 | 10 | 11 | 12 |
| Amount blended in masterbatch | | | | | | | |
| Parts | Concentrated natural | 100 | 100 | 100 | 100 | 100 | 100 |
| by | rubber latex (dry | | | | | | |
| mass | rubber content) | | | | | | |
| | Carbon black | 5 | 5 | 5 | 10 | 10 | 10 |
| | CNF1 | 8 | 18 | 28 | 5 | 13 | 23 |
| | CNF2 | — | — | — | — | — | — |
| | CNF3 | — | — | — | — | — | — |
| Amount blended in rubber composition | | | | | | | |
| Parts | Masterbatch | 113 | 123 | 133 | 115 | 126 | 133 |
| by | Natural rubber | — | — | — | — | — | — |
| mass | (RSS #3) | | | | | | |
| | Carbon black | — | — | — | — | — | — |
| | Zinc oxide | 3 | 3 | 3 | 3 | 3 | 3 |
| | Stearic acid | 2 | 2 | 2 | 2 | 2 | 2 |
| | Wax | 1 | 1 | 1 | 1 | 1 | 1 |
| | Antioxidant A | 2 | 2 | 2 | 2 | 2 | 2 |
| | Antioxidant B | 1 | 1 | 1 | 1 | 1 | 1 |
| | Sulfur | 2 | 2 | 2 | 2 | 2 | 2 |
| | Vulcanization | 1 | 1 | 1 | 1 | 1 | 1 |
| | accelerator | | | | | | |
| Physical | E′ | 124 | 129 | 152 | 124 | 127 | 149 |
| properties | tanδ | 90 | 93 | 97 | 91 | 90 | 94 |

E′, i.e., storage modulus, of vulcanized rubber prepared with CNF1 was better than that of vulcanized rubber prepared with CNF2 and that of vulcanized rubber prepared with CNF3 (see, for example, Working Example 3, Comparative Example 6, and Comparative Example 12).

Moreover, tan δ of vulcanized rubber prepared with CNF1 was not much different from that of vulcanized rubber prepared with CNF2 (tan δ of vulcanized rubber prepared with CNF2 was smaller than that of vulcanized rubber prepared with CNF3) (see, for example, Working Example 3 and Comparative Example 6).

Based on such results, it is fair to say that it was possible using CNF1 to manufacture a masterbatch capable of serving as raw material for vulcanized rubber having an excellent balance between ability to achieve reduced heat generation and rigidity.

It should be noted that the effect whereby CNF1 caused improvement in E was able to be elicited to even greater degree as a result of employment of an operation in which there was mixture of three components, i.e., cellulose nanofiber slurry, concentrated natural rubber latex, and carbon black slurry. For example, where operations were employed in which there was mixture of two components, i.e., cellulose nanofiber slurry and concentrated natural rubber latex, the vulcanized rubber at Working Example 3 prepared with CNF1 was 52 points better than that of the vulcanized rubber at Comparative Example 6 prepared with CNF2, and was 33 points better than that of the vulcanized rubber at Comparative Example 12 prepared with CNF3. On the other hand, where operations were employed in which there was mixture of three components, i.e., cellulose nanofiber slurry, concentrated natural rubber latex, and carbon black slurry, the vulcanized rubber at Working Example 6 prepared with CNF1 was 55 points better than that of the vulcanized rubber at Comparative Example 9 prepared with CNF2, and was 36 points better than that of the vulcanized rubber at Comparative Example 15 prepared with CNF3. Thus, employment of operations in which there was mixture of three components resulted in an increase in the difference between the E of the vulcanized rubber prepared with CNF1 and the E of the vulcanized rubber prepared with CNF2, and employment of such operations also resulted in an increase in the difference between the E of the vulcanized rubber prepared with CNF1 and the E of the vulcanized rubber prepared with CNF3.

In addition, with CNF1, it was also possible to cause worsening of heat generation due to addition of cellulose nanofiber to be suppressed to even greater degree as a result of employment of an operation in which there was mixture of three components, i.e., cellulose nanofiber slurry, concentrated natural rubber latex, and carbon black slurry. For example, where operations were employed in which there was mixture of two components, i.e., cellulose nanofiber slurry and concentrated natural rubber latex, the vulcanized rubber at Working Example 3 prepared with CNF1 was 3 points worse than (i.e., there was a difference of 3 points as compared with) that of the vulcanized rubber at Comparative Example 6 prepared with CNF2, and was 18 points better than that of the vulcanized rubber at Comparative Example 12 prepared with CNF3. On the other hand, where operations were employed in which there was mixture of three components, i.e., cellulose nanofiber slurry, concentrated natural rubber latex, and carbon black slurry, the vulcanized rubber at Working Example 6 prepared with CNF1 had the same number of points as that of the vulcanized rubber at Comparative Example 9 prepared with CNF2, and was 20 points better than that of the vulcanized rubber at Comparative Example 15 prepared with CNF3.

1. A tire masterbatch comprising:
natural rubber; and
cellulose nanofiber;
wherein at least a portion of the cellulose nanofiber is such that length is 10 μm to 20 μm, and a ratio of the length to a diameter is 1000 to 2000.

2. The tire masterbatch according to claim 1 wherein
the tire masterbatch further comprises a rubber component that comprises the natural rubber; and
the cellulose nanofiber is present in an amount that is not less than 0.1 part by mass but not greater than 60 parts by mass per 100 parts by mass of the rubber component.

3. A tire masterbatch manufacturing method comprising:
an operation in which at least a cellulose nanofiber slurry and a natural rubber latex are mixed to prepare a liquid mixture; and
an operation in which the liquid mixture is coagulated;
wherein at least a portion of cellulose nanofiber within the cellulose nanofiber slurry is such that length is 10 μm to 20 μm, and a ratio of the length to a diameter is 1000 to 2000.

4. The tire masterbatch manufacturing method according to claim 3 wherein at the operation in which the liquid mixture is prepared, at least the cellulose nanofiber slurry, the natural rubber latex, and a carbon black slurry are mixed.

5. The tire masterbatch manufacturing method according to claim 3 wherein the length at the portion of the cellulose nanofiber is not less than 13 μm.

6. The tire masterbatch manufacturing method according to claim 3 wherein the length at the portion of the cellulose nanofiber is not less than 15 μm.

7. The tire masterbatch manufacturing method according to claim 3 wherein the ratio at the portion of the cellulose nanofiber is not less than 1300.

8. The tire masterbatch manufacturing method according to claim 3 wherein the ratio at the portion of the cellulose nanofiber is not less than 1500.

9. The tire masterbatch manufacturing method according to claim 3 wherein the ratio at the portion of the cellulose nanofiber is less than 2000.

10. The tire masterbatch manufacturing method according to claim 3 wherein
the cellulose nanofiber is present in the liquid mixture in an amount that is not less than 0.1 part by mass but not greater than 60 parts by mass per 100 parts by mass of dry rubber content in the natural rubber latex.

11. The tire masterbatch manufacturing method according to claim 3 further comprising:
an operation in which a coagulum obtained by the coagulation of the liquid mixture is dewatered.

12. A tire manufacturing method comprising:
an operation in which a tire masterbatch is prepared by the tire masterbatch manufacturing method according to claim 3;
an operation in which the tire masterbatch is used to prepare a rubber composition; and
an operation in which the rubber composition is used to prepare an unvulcanized tire.

13. The tire manufacturing method according to claim 12 wherein
the operation in which the rubber composition is prepared comprises kneading at least the tire masterbatch and a compounding ingredient to prepare a rubber mixture, and kneading at least the rubber mixture and sulfur to obtain the rubber composition.

14. A tire rubber composition comprising:
natural rubber; and
cellulose nanofiber;
wherein at least a portion of the cellulose nanofiber is such that length is 10 μm to 20 μm, and a ratio of the length to a diameter is 1000 to 2000.

15. A tire prepared through use of the rubber composition according to claim 14.
